(19) United States
(12) Patent Application Publication
(10) Pub. No.: US 2023/0120485 A1
(43) Pub. Date: Apr. 20, 2023

(54) Token-For-Token Provisioning

(71) Applicant: Visa International Service Association, San Francisco, CA (US)

(72) Inventors: Ramesh Shankar, San Mateo, CA (US); Anjana Surin, Foster City, CA (US); Sayeed Mohammed, Foster City, CA (US); Pinesh Roy, Foster, CA (US)

(73) Assignee: Visa International Service Association, San Francisco, CA (US)

(21) Appl. No.: 17/801,756

(22) PCT Filed: Apr. 30, 2021
(86) PCT No.: PCT/US2021/030223

§ 371 Date: Aug. 23, 2022

Related U.S. Application Data
(60) Provisional application No. 63/065,445, filed on Aug. 13, 2020.
(60) Provisional application No. 63/018,360, filed on Apr. 30, 2020.

(51) Int. Cl. H04L 9/32

(52) U.S. Cl. CPC H04L 9/3213

(57) ABSTRACT

The present embodiments relate to systems and methods for token-for-token provisioning. A server computer can receive a message from a second token requestor. The message can include a request for a second token and can include a first token or the message can include a cryptogram request message. The server computer can transmit a provisioning request message to an authorizing entity computer requesting an authentication of a credential and receive a provisioning response message from the authorizing entity computer authenticating the credential. Any of the server computer or the authorizing entity computer can generate the second token. The server computer can provide the second token to a second token requestor for use in a recurring transaction. The first token and the second token can both be associated with a credential.

### CROSS-REFERENCES TO RELATED APPLICATIONS

This application is a PCT application, which claims the benefit of priority of U.S. Provisional Application No. 63/018,360, filed on Apr. 30, 2020, and U.S. Provisional Application No. 63/065,445, filed on Aug. 13, 2020, which are herein incorporated by reference in its entirety for all purposes.

### BACKGROUND

Tokens can be used to access various resources. In some cases, a single token can be stored in different places such as on a mobile phone and/or on a remote server. A user can access various resources using the tokens stored in the different locations. Problems arise, however, if one token on one device is removed for some reason. For instance, a software change on a phone may erase a token on the phone. The token may subsequently be rendered invalid for subsequent use. In this case, the corresponding token that is stored on the remote server may not be able to process further interactions using the stored token.

Embodiments address these and other problems, individually and collectively.

### SUMMARY

One embodiment of the invention provides a method performed by a server computer. The method can include receiving a message. The method can also include transmitting a provisioning request message to an authorizing entity computer. The method can also include receiving a provisioning response message from the authorizing entity computer. The method can also include providing a second token to a second token requestor. The second token can be associated with a first token stored in a first token requestor. The first token and the second token are associated with a credential.

Another embodiment of the invention provides a server computer. The server computer can include a processor and a non-transitory computer readable medium. The non-transitory computer readable medium can comprise instructions, executable by the processor, to cause the processor to receive a message. The non-transitory computer readable medium can further cause the processor to transmit a provisioning request message to an authorizing entity computer for verification of a credential associated with a first token specific to a first token requestor.

The non-transitory computer readable medium can further cause the processor to receive a provisioning response message from the authorizing entity computer indicating whether the credential is verified. The non-transitory computer readable medium can further cause the processor to obtain the access token. The first token and the second token can both be associated with the credential. The non-transitory computer readable medium can further cause the processor to provide the second token to a second token requestor. The second token can be associated with the first token stored in the first token requestor.

Another embodiment of the invention provides a method performed by a second token requestor. The method can include receiving a first token from a first token requestor. The method can also include transmitting a provisioning request message requesting a second token from a token service computer. The method can also include receiving from the token service computer, the second token. The second token and the first token can each be associated with a credential.

Further details regarding embodiments of the invention can be found in the Detailed Description and the Figures.

### BRIEF DESCRIPTION OF THE DRAWINGS

FIG. 1 illustrates a block diagram of an example asynchronous token-for-token process according to an embodiment.

FIG. 2 illustrates a mobile communication device according to an embodiment.

FIG. 3 shows an example second token requestor according to an embodiment.

FIG. 4 shows an example server computer according to an embodiment.

FIG. 5 shows an example authorizing entity computer according to an embodiment.

FIG. 6 illustrates an example signaling process for token to token provisioning according to an embodiment.

FIG. 7 shows a block diagram of a building access system according to an embodiment.

FIG. 8 shows a block diagram of a transaction processing system that can use a user device with access data (e.g., a token) according to an embodiment.

### DETAILED DESCRIPTION

Before discussing embodiments of the invention, some description of some terms may be helpful.

A “communication device” may comprise any suitable electronic device that may be operated by a user, which may also provide remote communication capabilities to a network. A “mobile communication device” may be an example of a “communication device” that can be easily transported. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile communication devices include mobile phones (e.g. cellular phones), PDAs, tablet computers, net books, laptop computers, personal music players, hand-held specialized readers, etc. Further examples of mobile communication devices include wearable devices, such as smart watches, fitness bands, ankle bracelets, rings, earrings, etc., as well as automobiles with remote communication capabilities. In some embodiments, a mobile communication device can function as a payment device (e.g., a mobile communication device can store and be able to transmit payment credentials for a transaction).

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of payment devices include payment cards, smart media, transponders, and the like. If the payment device is in the form of a debit, credit, or smartcard, the payment device may also optionally have features such as magnetic stripes. Such devices can operate in either a contact or contactless mode.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, and verification values such as CVV, dCVV, CVV2, dCVV2, and CVC3 values.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier. Further, tokenization may be applied to any other information that may be replaced with a substitute value (i.e., token). Tokenization enhances transaction efficiency and security.

A “token issuer,” token provider” or “token service system” can include a system that services tokens. In some embodiments, a token service system can facilitate requesting, determining (e.g., generating) and/or issuing tokens, as well as maintaining an established mapping of tokens to primary account numbers (PANs) in a repository (e.g. token vault). In some embodiments, the token service system may establish a token assurance level for a given token to indicate the confidence level of the token to PAN binding. The token service system may include or be in communication with a token vault where the generated tokens are stored. The token service system may support token processing of payment transactions submitted using tokens by de-tokenizing the tokens to obtain the actual PANs. In some embodiments, a token service system may include a tokenization computer alone, or in combination with other computers such as a transaction processing network computer. Various entities of a tokenization ecosystem may assume the roles of the token service provider. For example, payment networks and issuers or their agents may become the token service provider by implementing the token services according to embodiments of the present invention.

A “token domain” may indicate an area and/or circumstance in which a token can be used. Examples of token domains may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e. token domain restriction controls) may be established as part of token issuance by the token service provider that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

A “token expiry date” may refer to the expiration date/time of the token. The token expiry date may be passed among the entities of the tokenization ecosystem during transaction processing to ensure interoperability. The token expiration date may be a numeric value (e.g. a 4-digit numeric value). In some embodiments, the token expiry date can be expressed as a time duration as measured from the time of issuance.

A “token request message” may be an electronic message for requesting a token. A token request message may include information usable for identifying a payment account or digital wallet, and/or information for generating a payment token. For example, a token request message may include payment credentials, mobile device identification information (e.g. a phone number or MSISDN), a digital wallet identifier, information identifying a tokenization service provider, a merchant identifier, a cryptogram, and/or any other suitable information. Information included in a token request message can be encrypted (e.g., with an issuer-specific key).

A “token response message” may be a message that responds to a token request. A token response message may include an indication that a token request was approved or denied. A token response message may also include a payment token, mobile device identification information (e.g. a phone number or MSISDN), a digital wallet identifier, information identifying a tokenization service provider, a merchant identifier, a cryptogram, and/or any other suitable information. Information included in a token response message can be encrypted (e.g., with an issuer-specific key).

A “token requestor” may be an entity such as an application, a device, or a system that is configured to request and/or receive one or more tokens, and may perform actions associated with the one or more tokens. For example, a token requestor can request registration with a network token system, request token generation, token activation. token de-activation, token exchange, other token life-cycle management related processes, and/or any other token related processes. A requestor may interface with a network token system through any suitable communication networks and/or protocols (e.g., using HTTPS, simple object access protocol (SOAP) and/or an extensible markup language (XML) interface). Some non-limiting examples of token requestors may include devices operated by employees of employers, consumers, or users seeking to access locations or data, third party wallet providers, issuers, acquirers, merchants, and/or payment processing networks. In some embodiments, a token requestor can request tokens for multiple domains and/or channels.

A “token requestor identifier” may include any characters, numerals, or other identifiers that can identify a token requestor. In some embodiments, a unique token requestor identifier may be assigned for each domain for a token request associated with the same token requestor. For example, a token requestor identifier can identify a pairing of a token requestor (e.g., a mobile device, a mobile wallet provider, etc.) with a token domain (e.g., e-commerce, contactless, etc.). A token requestor identifier may include any format or type of information. For example, in one embodiment, the token requestor identifier may include a numerical value such as a ten digit or an eleven digit number (e.g., 4678012345).

A “user” may include an individual. In some embodiments, a user may be associated with one or more personal accounts and/or mobile devices. The user may also be referred to as a cardholder, account holder, or consumer in some embodiments.

A “resource provider” may be an entity that can provide a resource such as goods, services, information, and/or access. Examples of resource providers includes merchants, data providers, transit agencies, governmental entities, venue and dwelling operators, etc.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers. A server computer may also include a cloud server.

A “provisioning request message” can include a message that requests the provisioning of a token. In some embodiments, a provisioning request message may be transmitted from a server computer to an authorizing entity computer to provision a second token (or access token). In some embodiments, the provisioning request message can request that a credential received from a second token requestor be validated.

A “provisioning response message” can include a message that responds to a provisioning request message. In some embodiments, a provisioning response message can be transmitted from the authorizing entity computer to a server computer that sent a provisioning request message. The provisioning response message may include an indication of whether a credential that was sent to an authorizing entity computer by the server computer is valid or not. In the case where the authorizing entity computer has validated the credential, the provisioning response message may also include an access token.

In some cases, a mobile wallet on a communication device such as a mobile phone can provide a device bound token to a resource provider application (e.g., a merchant application) on the communication device. The device bound token can be used in both individual and recurring transactions. An example of an individual transaction is one in which a user uses a communication device to interact with an access device such as a point of sale terminal. The communication device can transmit the device bound token stored in the mobile wallet to the access device, which can process a transaction. An example of a recurring transaction may be a transaction in which a user authorizes a resource provider (e.g., via a resource provider application) to repeatedly use the device bound token to conduct a recurring payment transaction. A device bound token may be stored in memory (e.g., a secure element) on the communication device. The device bound token may also be stored at a remote server if it is used, for example, by a resource provider to conduct recurring transactions.

In some cases, an resource provider application on a communication device may retrieve a device bound token associated with a real credential (e.g., a real primary account number) from a memory of the communication device to conduct an transaction. For example, the resource provider application may communicate with an application server associated with the resource provider application to store the device bound token, and initiate a transaction such as a payment transaction using the device bound token. If a user deletes the device bound token in the memory of the communication device, any subsequent transactions conducted by the resource provider application and its application server using the device bound token may fail.

As an illustration, a device bound token associated with a real credential may be stored in the memory of the communication device by a first mobile wallet application on the communication device. The user may wish to change mobile wallets at some time in the future, and may delete the first mobile wallet application in favor of a second mobile wallet application. Deletion of the first mobile wallet application may cause the communication device to delete the device bound token in the memory. Deletion of the device bound token in the memory then may cause the user of the communication device to request another device bound token associated with the real credential. That is, once the first token is deleted, a communication may be sent to a server computer such as a token server computer indicating that the first token was deleted. The server computer may then send a second token to the communication device to replace the first token. The server computer may then no longer allow for the processing of any further requests with the first token. This can cause problems, since the resource provider application may have stored the previously received device token in another portion of the memory of the communication device, or at its corresponding application server. The resource provider application or its application server may still have the first token, and may attempt to process transactions using the first token. Such transactions will be rejected, since the first token would no longer be valid.

The present embodiments relate to generating a token using a token-for-token provisioning process. A server computer can obtain a message requesting an access token (which can be an example of a second token) associated with a device token and a real credential, from a communication device (e.g., a mobile phone). The token request message can include the device token (which can be an example of a first token). The device token can be specific to the communication device and, in many cases, may only be used to initiate transactions that include an interaction with the communication device (e.g., interactions where the communication device is tapped with an access device (e.g., POS equipment)).

In embodiments, after receiving the message requesting the access token, the server computer can transmit a provisioning request message for the access token to an authorizing entity computer for the server computer or authorizing entity computer to generate the access token. As noted above, the device token and the access token can both be associated with a real credential such as a primary account number. Further, the access token can be used by a resource provider that conducts recurring transactions (e.g., recurring monthly transactions for a video streaming service). The provisioning request message may include information including, but not limited to the real credential and/or the device token.

After receiving the provisioning request message, the authorizing entity computer can evaluate the content of the provisioning request message and can determine if the provisioning request message is to be approved or declined. In some embodiments, the authorizing entity computer may evaluate the real credential and/or the device token to determine if there are any issues such as fraud associated with them. Once the authorizing entity computer approves of the provisioning request message, it can transmit a provisioning response message to the server computer. The provisioning response message could include an indication of the whether or not provisioning of an access token is approved by the authorizing entity computer. The provisioning response message may also include the device token and/or the real credential.

The server computer can then receive the provisioning response message. After determining that the authorizing entity computer approves of the provisioning of the access token, the server computer can provide the access token to the communication device (which may be an example of a first token requestor) or a second token requestor such as a resource provider application or its application server. Once the second token requestor possesses the access token, the second token requestor may then conduct transactions using the access token. If the device token is invalidated or deleted for some reason, then the access token can still be used and is still associated with the real credential.

Some embodiments of the invention can provide an access token that is related to a device token and a real credential to a second token requestor (e.g., a resource provider computer, a resource provider application, etc.). The access token may be a cloud token or cloud access token if it is stored in the cloud in a cloud computing system. In some embodiments, a first token requestor can be a communication device, which can conduct a transaction using a device token. After the transaction is conducted with the device token, a token service computer, or a processor computer in communication with the token service computer, can use the device token to request or obtain a cloud token for the communication device. This can be done in an a asynchronous manner and need not be done contemporaneously with the transaction conducted using the device token. Recurring transactions can then be conducted using the cloud token by the second token requestor on behalf of a user.

The cloud token can be based on the same real credential (e.g., PAN) as a device token that is stored on the communication device, but may be independent of the device token. While the cloud token can be used to conduct remote transactions such as e-commerce transactions, a device token can be used to conduct a transaction at a physical point of sale. If the device token is deleted (on purpose or accidentally), the cloud token may be unaffected and recurring merchant transactions will continue to be processed. Embodiments can avoid the need for the token requestor computer to make multiple calls to a token service computer obtain to obtain multiple tokens from the token service computer.

Embodiments of the invention have a number of advantages. For example, one alternative way to provision the second token to the second token requestor would be to include a primary credential such as a PAN in the provisioning request message. However, this would allow the second token requestor to be in possession of the primary credential which is undesirable. Further, if the first token requestor is a mobile phone that possesses only the device token, then the first token requestor may not have access to the real credential associated with the device token. Yet another advantage is that the second token can still be active and tied to the underlying primary credential, even if the first token is inactivated for some reason. For example, the first token requestor could be a mobile phone, and the user of the mobile phone may purchase a new mobile phone. In this case, the original device token could be inadvertently deleted during the transfer of information to the new phone. If this occurs, the second token held by the requiting token requestor may still be active even if the first token (device token) is rendered inactive for some reason.

Further, as described herein, a cryptogram can be provided to initiate an initial transaction using the device token. The system can also generate a cloud access token and bind the cloud access token to a communication device asynchronously from the providing of the cryptogram. The cloud access token can be provided to the communication device for performance of subsequent transactions (e.g., a recurring transaction).

In these embodiments, rather that having two separate token requests, it is possible for the token request for a second token to occur automatically without user intervention. The second token can be a cloud based access token and can be requested using a first token, and can occur asynchronously with a payment transaction. Device binding and authorization for the second token may take a few seconds, which can make it difficult to provide the second token in a synchronous manner with the use of the first token.

Further, embodiments of the invention can relate to an asynchronous token-for-token procedure. Particularly, to initiate an initial transaction, the communication device can transmit a cryptogram request to a server computer requesting a cryptogram. The cryptogram request can include a device token specific to the communication device, and the device token can be used to identify a credential associated with a user device that can be used to generate or obtain the cloud access token. The initial transaction can be initiated using the received cryptogram.

The server computer can perform a token-for-token retrieval process with an authorizing entity computer to obtain a cloud access token specific to the resource provider. This can be performed asynchronously from the process of providing of the cryptogram. The cloud access token can be bound to the communication device, and the cloud access token and the device binding result can be provided to the communication device. The cloud access token can then be used to perform recurring transactions.

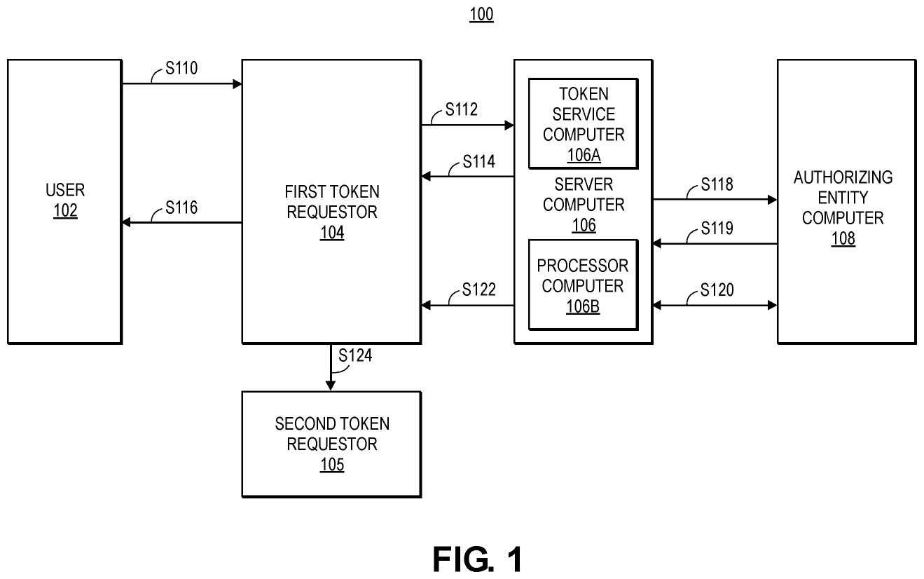

FIG. 1 illustrates a block diagram 100 of a system according to an embodiment. An asynchronous token-for-token process flow according to an embodiment is also shown. In this example, a second token such as an access token can be delivered to a second token requestor at a time that is independent of the time of receipt (by a server computer) of a message, which starts the process for provisioning the second token. For example, the message which starts the process for provisioning of the second token may be a cryptogram request message comprising a first token that is received from a first token requestor by a server computer. The cryptogram request message may be a message that is sent as part of a payment transaction that the first token requestor conducts using the first token. At a later time, independent of receipt of the cryptogram request message, the second token can be provided to the second token requestor.

FIG. 1 shows a user 102 that may operate a first token requestor 104, which may be a communication device. The first token requestor 104 may be, for example, a mobile phone or a laptop computer operated by the user 102. The first token requestor 104 may be in operative communication with a second token requestor 105. The second token requestor 105 may be an application server computer associated with an application on the first token requestor 104. The application may be a resource provider application such as a streaming service application, and the application server computer may be a computer that works with the streaming service application.

FIG. 1 also shows a server computer 106 in operative communication with the first token requestor 104. The server computer 106 may comprise an suitable combination of subsystems including a token service computer 106A and a processor computer 106B. Note that the token service computer 106A and the processor computer 106B may be independently functioning computers and the server computer 106 may include a network of computers including them. In other embodiments, the server computer 106 may contain one or more computers with software modules that would perform the functions of the token service computer 106A and the processor computer 106B. An authorizing entity computer 108 may be in communication with the server computer 106, its components, the token service computer 106A and the processor computer 1066. Further details regarding the server computer 106, the authorizing entity computer 108, and the first token requestor 104 in the form of a communication device are described below.

Each of the entities in FIG. 1 including the first token requestor 104, the second token requestor 106, the server computer 106, the token service computer 130, the processor computer 150, and the authorizing entity computer 108 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, etc.); and/or the like.

A process according to embodiments may now be described.

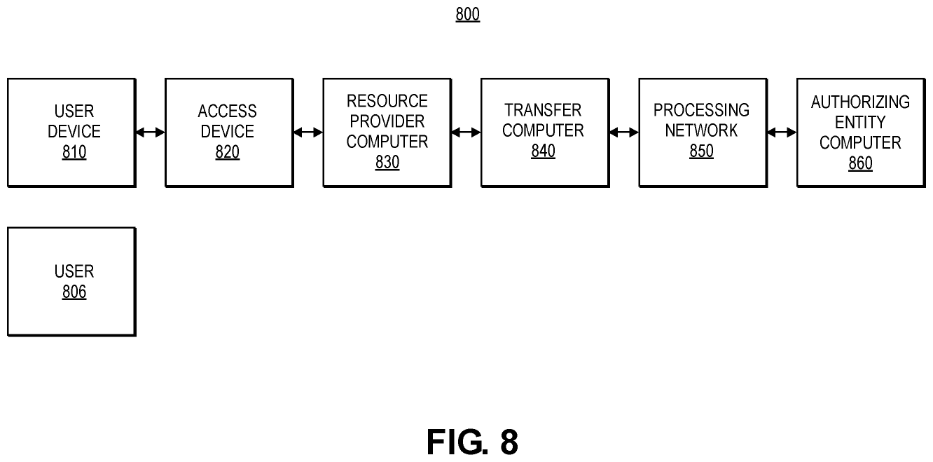

At step S110, the user 102 may initiate a checkout process using a first token requestor 104. The first token requestor 104 may be a communication device such as a mobile phone operated by the user 102. The checkout process can include a request to perform a transaction with a resource provider operating a resource provider computer (now shown) using the first token requestor 104. For example, the resource provider could be a supermarket and the user 102 can use the first token requestor 104 to conduct a payment at a POS (point of sale) terminal at the supermarket. The user 102 can initiate a wallet application on the first token requestor 104 and can provide the first token to the POS terminal which can process a payment transaction using the first token. Exemplary payment transactions using tokens are described below with respect to FIG. 8. However, in some cases, the first token requestor 104 may need to have a cryptogram that is transmitted along with the first token to the POS terminal. The cryptogram can be a single use or multiple use cryptogram and can serve as additional authentication data when the first token is used to conduct a payment. The cryptogram may also be used to restrict the domain usage for the first token. For example, one cryptogram may be valid only when the first token is used for electronic commerce transactions. Another cryptogram may only be used when the first token is used in person transactions.

At step S112, when performing a transaction such as a payment transaction, the first token requestor 104 can transmit a message such as a cryptogram request message the token service computer 106A in server computer 106. The token service computer 106A can receive the cryptogram request message from the first token requestor 104. The cryptogram request message can include a device token (e.g., an example of a first token) specific to the first token requestor 104, which may be stored in a secure memory in the token requestor 104. The first token may be a sixteen digit number that is a substitute for a real credential such as a real sixteen digit PAN.

In some embodiments, the token service computer 106A in the server computer 106 can search a data store with device token—real credential pairings, using the device token, to determine the real credential associated with the device token. The credential and/or the device token can be provided in the request for the access token as described below. The token service computer 106A can then generate a cryptogram for the device token. In some embodiments, the cryptogram may be derived from the real credential or the device token, and some dynamic data (e.g., a date, time, transaction amount, counter, etc.) using a cryptographic algorithm and a cryptographic key. In some embodiments, the first token requestor 104 needs to obtain a cryptogram for every transaction or every few transactions in order to use the device token.

At step S114, after the cryptogram is generated, the token service computer 106A can transmit the cryptogram to the first token requestor 104. Once the cryptogram is received by the first token requestor, the first token requestor 104 may perform a transaction (e.g., an in person transaction or an e-commerce transaction) with a resource provider using the device token and the cryptogram. More specifically, the resource provider may transmit an authorization request message to the server computer 106. The server computer 106 may use the token service computer 106A to validate the cryptogram and to de-tokenize the device token and to obtain the real credential (e.g., the real PAN). The authorization request message may be modified with the real credential and may be transmitted to the authorizing entity computer 108 for approval. The processor computer 1066 may contain a routing table to route the authorization request message to the authorizing entity computer 108. The authorizing entity computer 108 may return an authorization response message back to the resource provider via the server computer 106 authorizing or declining the transaction. Further details regarding this are below with respect to the flow in FIG. 8. In some embodiments, the resource provider that conducts this transaction can be a resource provider that operates the second token requestor 105, or it may be an entity that operates a computer or devices that are independent of the second token requestor 105.

At step S116, after the payment transaction is completed, the first token requestor 104 can provide a payment outcome message to the user 102. The payment outcome message can indicate that the transaction conducted with the resource provider using device token and the cryptogram was successful.

At step S118, after the payment transaction is completed and at a time that is not dependent upon the time that the payment transaction was completed, the server computer 106 and/or the token service computer 106A can transmit a request for an access token (an example of a second token) to the authorizing entity computer 108. The request for the access token can be a provisioning request message and may be submitted via an API or via any other suitable mechanism. The request for the access token can include the device token and/or the real credential. The authorizing entity computer 108 can be configured to authenticate data provided in the request for the access token. For example, the authorizing entity computer 108 can determine if the device token and/or the real credential is valid, not on a blacklist, etc. If the authorizing entity computer 108 determines that the request for the access token is valid and legitimate, then it may generate a provisioning response message indicating that the provisioning of an access token is approved.

In step S119, the server computer 106 can receive the provisioning response message from the authorizing entity computer 108. The message can include the access token, or it may contain an instruction for the server computer 106 to provide the access token to the first token requestor 104 or the second token requestor 105 via the first token requestor 104.

As noted above, the device token (e.g., example of a first token) and the access token (e.g., an example of a second token) can both be associated with a real credential. For example, the device token can be a first payment token relating to the credential and is stored in a communication device (an example of a first token requestor), and the access token can be a second payment token that is stored at an application server (an example of a second token requestor) that operates an application on the communication device.

In some embodiments, the server computer 106 can update a token store to associate the access token with the credential. The token store can map an identifier uniquely identifying the communication device, the device token, and the cloud access token with a credential. The credential can include a primary account number (PAN).

At step S120, the authorizing entity computer 108 can bind the access token to a identifier unique to the first token requestor 104. In other words, the authorizing entity computer can be configured to bind a device identifier for the first token requestor 104 to the access token (or second token). The access token can be specific to a resource provider for performance of recurring transactions.

At step S122, the server computer 106 can send the access token to the first token requestor 104. At step S124, the first token requestor 104 can optionally provide the access token to the second token requestor 105. For example, the first token requestor 104 may receive the access token and it may be entered into an application on the first token requestor 104 that is operated by the second token requestor 105, which may be an application server. In other embodiments, the first token requestor 104 can store the access token for future use. The application server can receive the access token and then then store it for future use. These steps (S118, S119, S120, S122, S124) can be performed at a second time after transmission of the cryptogram to the token requestor 104 as described in step S114, thus providing an asynchronous token provisioning process. The providing of the access token can include a device binding result indicative of the access token being bound to the identifier for the first token requestor.

In some embodiments, the access token is provided to the second token requestor (e.g., message as described in step S122) after the message S112 is received by the server computer. However, the second token is not provided in direct response to the receipt of the message in S112 by the server computer 106.

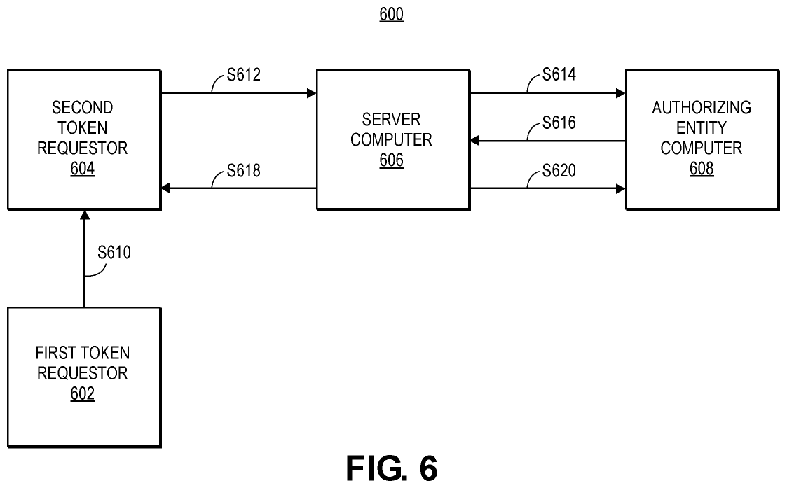

In the flow described above, a second token (e.g., the access token) is provided to the second token requestor 105 via the first token requestor 104. In the example described with reference to FIG. 6, below, the second token requestor can receive an access token directly from the server computer.

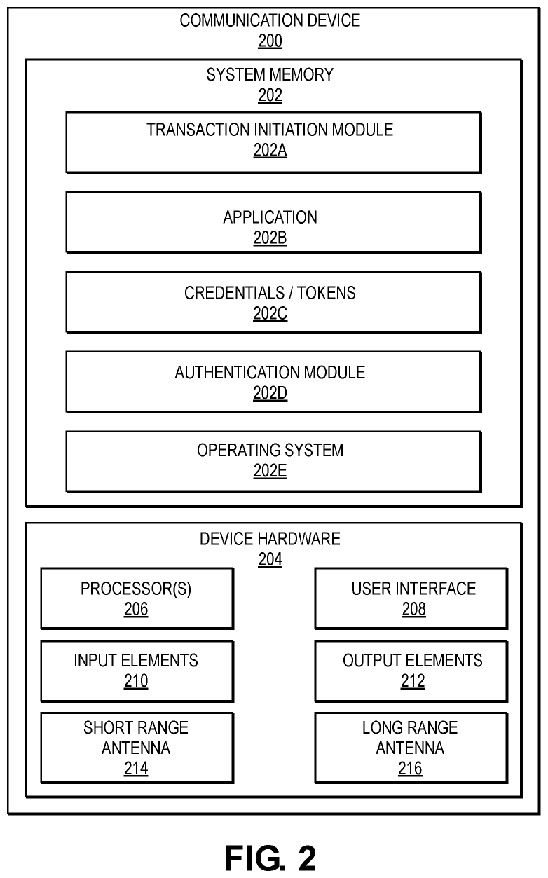

FIG. 2 illustrates a block diagram of a mobile communication device 200 according to an embodiment. The mobile communication device 200 may be an example of a first token requestor, or even a second token requestor. Mobile communication device 200 may include device hardware 204 coupled to a system memory 202.

Device hardware 204 may include a processor 206, a short range antenna 214, a long range antenna 216, input elements 210, a user interface 208, and output elements 212 (which may be part of the user interface 208). Examples of input elements may include microphones, keypads, touchscreens, sensors, etc. Examples of output elements may include speakers, display screens, and tactile devices. The processor 206 can be implemented as one or more integrated circuits (e.g., one or more single core or multicore microprocessors and/or microcontrollers), and is used to control the operation of mobile communication device 200. The processor 206 can execute a variety of programs in response to program code or computer-readable code stored in the system memory 202, and can maintain multiple concurrently executing programs or processes.

The long range antenna 216 may include one or more RF transceivers and/or connectors that can be used by mobile communication device 200 to communicate with other devices and/or to connect with external networks. The user interface 208 can include any combination of input and output elements to allow a user to interact with and invoke the functionalities of mobile communication device 200. The short range antenna 209 may be configured to communicate with external entities through a short range communication medium (e.g. using Bluetooth, Wi-Fi, infrared, NFC, etc.). The long range antenna 219 may be configured to communicate with a remote base station and a remote cellular or data network, over the air.

The system memory 202 can be implemented using any combination of any number of non-volatile memories (e.g., flash memory) and volatile memories (e.g. DRAM, SRAM), or any other non-transitory computer readable storage medium, or a combination thereof media.

The system memory 202 may also store a transaction initiation module 202A, one or more applications 202B credentials and/or tokens 202C, an authentication module 202D and an operating system 202E, The transaction initiation module 202A may include instructions or code initiating and conducting a transaction with an external device such as an access device or a processing computer. It may include code, executable by the processor 206, for generating and transmitting authorization request messages, as well as receiving and forwarding authorization response messages. It may also include code, executable by the processor 206, for forming a local connection or otherwise interacting with an external access device.

The system memory 202 can also include one or more applications 202B. Example of applications may include digital wallet applications, resource provider applications, building access applications, data access applications, etc.

System memory 202 may also store credentials and/or tokens 202C. Credentials may also include information identifying the mobile communication device 200 and/or the user of the mobile communication device 200.

The system memory 202 can comprise code, executable by the processor 206, to authenticate a user. This can be performed using user secrets (e.g., passwords) or user biometrics.

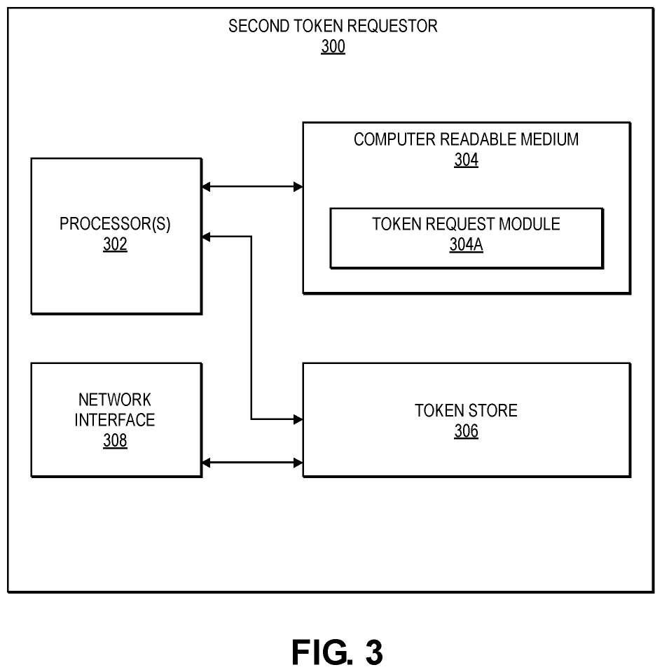

FIG. 3 shows an example second token requestor 300 according to an embodiment. In some embodiments, the second token requestor 300 can include a computing device associated with a resource provider that is in communication with communication device 200. For example, second token requestor 300 can provide instructions to execute an application on the communication device that is specific to the resource provider. The second token requestor 300 can request an access token for use in a recurring transaction. Additionally, the second token requestor 300 can obtain the access token via the communication device 200. The second token requestor 300 can include a processor 302 and a computer readable medium 304, a token store 306, and a network interface 308 coupled to the processor 302.

The computer readable medium 304 may comprise a token request module 304A. The tokenization request module 304A may comprise code that causes the processor 302 to request and obtain access tokens. For example, the token request module 304A may contain logic that causes the processor 302 to request an access token from a server computer by sending a provisioning request to a server computer. In response, an access token can be received from the server computer for use in recurring transactions. Each access token can be specific to the resource provider and the user device associated with the device token. A token record may then be stored in a token store 306 indicating that the payment token is associated with a certain user or a certain set of payment credentials.

The token store 306 may store tokens and their associated credentials in a database. The token store 306 may store data in a database such as an Oracle™ database.

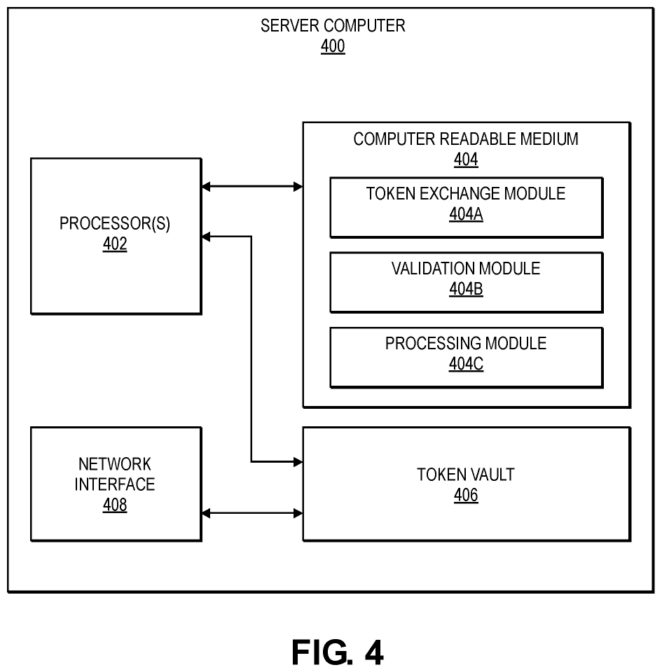

FIG. 4 shows an example server computer 400 according to an embodiment. The server computer 400 can include a computing device (or series of interconnected computing devices) that can be programmed to receive a message, transmit a provisioning request message to an authorizing entity computer, receive a provisioning response message from the authorizing entity computer, and provide the second token to a second token requestor device 300 as described herein. The server computer 400 can include a processor 402 and a computer readable medium 404, a token vault 406, and a network interface 408 coupled to the processor 402.

The computer readable medium 404 may comprise a token exchange module 404A. The tokenization exchange module 404A may comprise code that causes the processor 402 to obtain device tokens and obtain access tokens in a token-for-token provisioning process. For example, the token exchange module 404A may contain logic that causes the processor 402 to obtain an access token from an authorizing entity computer or generating an access token at the server computer 400.

The validation module 404B may comprise code that causes the processor 402 to validate token requests. For example, validation module 404B may contain logic that causes the processor 402 to authenticate a device token or user device data obtained in a message at the server computer 400. Further, the server computer 400 can obtain a credential using a device token by mapping the credential to the device token at the token store 406 using validation module 404B.

The processing module 404C may include code that causes the processor 402 to process transaction messages. Such processing may include routing message to appropriate authorizing entity computers, performing validations checks on data in messages, etc.

The token vault 406 may store tokens and their associated credentials in a database. The token vault 406 may store data in a database such as an Oracle™ database. The token vault 406 can map an access device with a credential (e.g., a PAN), the device token, other user device details, etc.

The computer readable medium 404 may comprise instructions, executable by the processor, to cause the one or more processor 402 to: receive a message; transmit a provisioning request message to an authorizing entity computer for verification of a credential associated with a first token specific to a first token requestor; receive a provisioning response message from the authorizing entity computer indicating whether the credential is verified; obtain a second token, the first token and the second token both associated with the credential; and provide the second token to a second token requestor, the second token being associated with the first token stored in a first token requestor

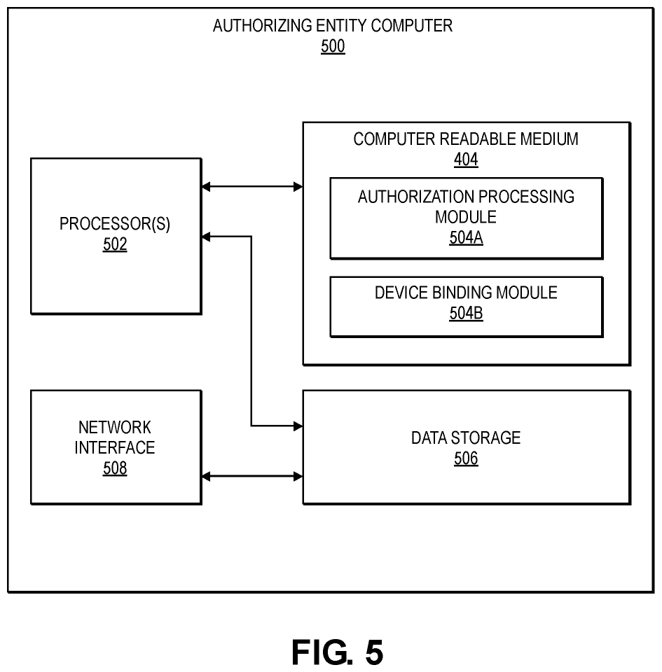

FIG. 5 shows an example authorizing entity computer 500 according to an embodiment. The authorizing entity computer 500 can include a computing device (or series of interconnected computing devices) to authorize data provided by server computer 400 and bind an access token to an identifier identifying the first token requestor (or communication device 200). The authorizing entity computer 500 can include a processor 502 and a computer readable medium 504, a data storage 506, and a network interface 508 coupled to the processor 502.

The authorizing entity computer 500 may comprise an authorization processing module 504A. The authorization processing module 504A can authenticate a credential or a device token to verify that the credential or device token is associated with a user device. In some instances, the authorizing entity computer 500 can generate the access token responsive to authenticating the credential or device token by the authorization processing module 504A.

The authorizing entity computer 500 may also comprise a device binding module 504B. The device binding module 504B can bind an access token to an identifier for the communication device 200. The device binding module 504B can also generate a binding result to be transmitted to the server computer 400 indicating a result of the token binding.

The data storage 506 can store credentials and corresponding user device data for use in authenticating a provided credential. For example, responsive to receiving a provisioning request message, the authorizing entity computer 500 can authenticate a credential (or device token) using the data storage 506 to determine that the credential (or device token) corresponds with a listed credential as associated with the user device in the data storage 506. The authorizing entity computer 500 can provisioning response message indicating an authorization of the credential (or device token). In some instances, the provisioning response message can include the access token.

As described above, a transaction can be initiated using details relating to a user device. For example, a user can initiate a transaction using a device token stored on the communication device. A transaction initiated using the device token may generally require the use of the communication device to initiate the transaction (e.g., by tapping the communication device to an access device of a resource provider), as the device token may be tied to the communication device.

However, in many instances, the user may subscribe to a service (e.g., a video streaming service) provided by a resource provider that includes a recurring transaction for access to the video streaming service, for example. In such a recurring transaction, the device token may not be desirable, as the communication device may not be utilized in initiating each recurring transaction. Rather, to initiate a recurring transaction, the resource provider can request an access token that is associated with the resource provider for use in initiating the recurring transaction.

Accordingly, a token requestor associated with a resource provider (e.g., a second token requesting device) can request an access token specific to the resource provider from a server computer using the device token. The server computer can obtain the request and interact with an authorizing entity computer to obtain an access token for the resource provider. The access token can be obtained at the token requestor and used by the resource provider to initiate a recurring transaction.

FIG. 6 shows a system including a first token requestor 602, a second token requestor 604, a server computer 606, and an authorizing entity computer 608. The server computer 606 in FIG. 6 may be similar or different than the server computer 106 in FIG. 1. In some embodiments, the server computer 606 has the characteristics of the token service computer 106A in FIG. 1. The authorizing entity computer 608 and the first and second token requestors 602, 604 are described above and the descriptions may be incorporated herein.

FIG. 6 illustrates an example signaling process 600 for token-for-token provisioning according to an embodiment. The flow in FIG. 6 differs from the flow described above with respect to FIG. 1, in that the flow in FIG. 6 does not include a specific cryptogram request message. The process flow described with respect to FIG. 6 can be performed entirely outside of a transaction process flow.

As noted above, the system can include a first token requestor 602 in communication with a second token requestor 604. As an illustration, the first token requestor 602 can be a mobile phone, and second token requestor 604 can be an application server that operates an application on the mobile phone. The application server may be operated by a resource provider such as a streaming service, a utility, a bank, a building operator, a transit agency etc.

At step S610, the first token requestor 602 (e.g., a mobile device, a wallet application, or wallet provider computer) may provide a device token to the second token requestor 604. The device token may be dynamic or static. An expiration date and a cryptogram such as a CVV2 or dCVV2 may accompany the device token. In some embodiments, the device token may be an example of a first token. In some embodiments, the device token may reside within a memory of the first token requestor 602. The memory may be a secure element that may be present on a mobile phone.

At step S612, the second token requestor 604 can generate a token request message (e.g., a provisioning API request) and may transmit it to the server computer 606. The token request message may comprise the device token (and optionally any expiration date and cryptogram) obtained from the first token requestor 602.

At step S614, after receiving the token request message comprising the device token, the server computer 606 can generate and send a token activation request (TAR) to the authorizing entity computer 608. The TAR message can be a provisioning request message. TAR may be in the form of an 0100 type financial message, or may be in any other suitable type of message (e.g., an HTTP request). The TAR may include the device token that was originally stored at the first token requestor 602. Alternatively or additionally, the TAR may include the real credential such as the original PAN (primary account number), original expiration date, and/or the original cryptogram associated with the device token that was received by the second token requestor 20 from the first token requestor 602. The server computer 606 can maintain a mapping between the original primary account identifier, the device token (i.e., the first token), and subsequently received second tokens.

In some embodiments, the provisioning request message that is sent by the server computer 606 to the authorizing entity computer 608 can include the device token. The server computer 606 can compare the device token with data included in the token store to identify a credential associated with the device token. The provisioning request message (e.g., message in step S614) can include the credential associated with the device token and/or the device token. After receiving the credential and/or device token, the authorizing entity computer 608 may determine if the account associated with the credential and/or the device token is valid, on a blacklist, etc. If the provisioning request message is valid, then the authorizing entity computer 608 may generate a provisioning response message.

At step S616, the authorizing entity computer 608 may send the provisioning response back to the server computer 606. In some embodiments, prior to sending the provisioning response message, the authorizing entity computer 608 may perform an identity and verification (ID&V) process on the user of the first token requestor 602, or otherwise determine if it is acceptable to provide an access token (an example of a second token) such as a second payment token to the second token requestor 604. The provisioning response may comprise the second token (and an accompanying expiration date and cryptogram) if the token request is approved. In other embodiments, the provisioning response message may include an approval indicator and an instruction for the server computer 606 to provide the access token to the second token requestor 604.

At step S618, a provisioning API response is sent from the server computer 606 to the second token requestor 604. If the provisioning response comprises the access token (and an accompanying expiration date and cryptogram), then the second token requestor 604 may store it for subsequent use. For example, the second token requestor 604 may be a recurring merchant that processes recurring transactions such as monthly payments for a subscription service.

At step S620, a notification advice message may be sent by the server computer 606 to the authorizing entity computer 608. This can inform the authorizing entity computer 608 that the second token has been provisioned to the second token requestor 604.

In the flows described with respect to FIG. 6, the access token (e.g., an example of a second token) is provided to the second token requestor 604 without passing through the first token requestor 602.

In some embodiments, the device token and the cloud access token may comprise an active and non-expired token. Further, the first token requestor and the second token requestor can have an established relationship with the server computer prior to the request for the cloud access token (e.g., at step 612). For instance, the server computer can communicate with first token requestor and the second token requestor to identify various parameters relating to the requestors, such as a device identifier, a resource provider identifier, etc.

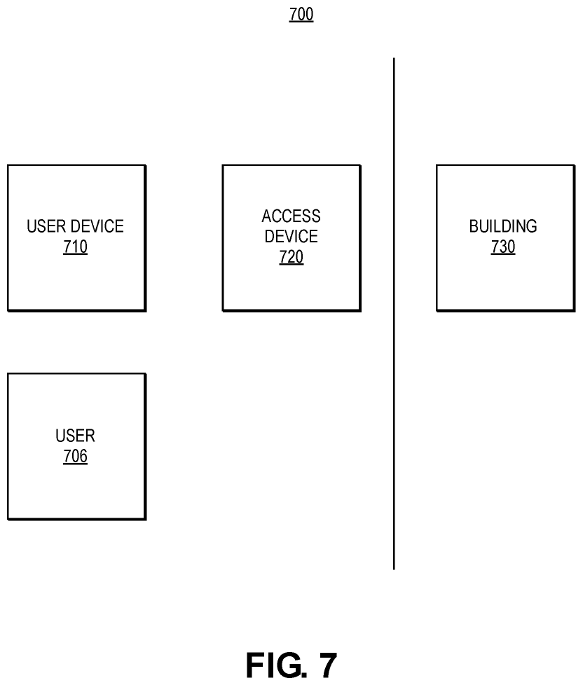

One the token requestors including the first and second token requestors have obtained their first and second tokens, respectively, they may conduct transactions such as those described with reference to FIGS. 7 and 8.

FIG. 7 shows a block diagram of a building access system 700 according to an embodiment. FIG. 7 shows a user device 710 operated by a user 706. The user device 710 has been provisioned with access data (e.g., a token) as described above. The user device 710 may be an example of a token requestor as described above. The user device 710 can interact with the access device 720 and pass access data to the access device 720. The access device 720 may locally verify the received access data or it may communicate with a remotely located authentication server computer (not shown). The remotely located authentication server computer may verify that the access data is authentic and may transmit a signal indicating this back to the access device 720. The access device 720 may then proceed to let the user 706 enter the building 730.

FIG. 8 shows a block diagram of a transaction processing system 800 that can use a user device 810 with access data (e.g., a token) according to an embodiment. FIG. 8 shows a user 806 that can operate a user device 810. The user device 810 may be an example of a token requestor as described above. The user 806 may use the user device 810 to pay for a good or service at a resource provider such as a merchant. The merchant may operate a resource provider computer 830 and/or an access device 820. The merchant may communicate with an authorizing entity computer 860 operated by an issuer, via a transport computer 840 operated by an acquirer and a processing network 850 such a payment processing network.

The payment processing network may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

A typical payment transaction flow using a user device 810 at an access device 820 (e.g., POS location) can be described as follows. A user 806 presents his or her user device 810 to an access device 820 to pay for an item or service. The user device 810 and the access device 820 interact such that access data from the user device 810 (e.g., PAN, a payment token, verification value(s), expiration date, etc.) is received by the access device 820 (e.g., via contact or contactless interface). The resource provider computer 830 may then receive this information from the access device 820 via an external communication interface. The resource provider computer 830 may then generate an authorization request message that includes the information received from the access device 820 (i.e. information corresponding to the user device 810) along with additional transaction information (e.g., a transaction amount, merchant specific information, etc.) and electronically transmits this information to a transport computer 840. The transport computer 840 may then receive, process, and forward the authorization request message to the authorizing entity computer 860 via the processing network 850 for authorization.

Once the transaction is authorized, the authorizing entity computer 860 may generate an authorization response message (that may include an authorization code indicating the transaction is approved or declined) and transmit this electronic message via its external communication interface to processing network 850. The processing network 850 may then forward the authorization response message to the transport computer 840, which in turn may then transmit the electronic message to comprising the authorization indication to the resource provider computer 830, and then to the access device 820.

If the access data is in the form of a token, then the processing network 850 may exchange the token for a real credential (e.g., a PAN). Any authorization request message may then be modified to include the real credential and it may be forward to the authorizing entity computer 860 for verification. The authorizing entity computer 860 can generate an authorization response message with an approval or decline. The authorization response message can be transmitted to the processing network 850, and the processing network 850 may replace the credential with the token. The processing network 850 may then transmit the authorization response message back to the access device 820.

At the end of the day or at some other suitable time interval, a clearing and settlement process between the resource computer 830, the transport computer 840, the processing network 850, and the authorizing entity computer 860 may be performed on the transaction.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

One or more features from any embodiment may be combined with one or more features of any other embodiment without departing from the scope of the disclosure.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

What is claimed is:

1. A method comprising:
receiving, by a server computer, a message;
after receiving the message, transmitting, by the server computer, a provisioning request message to an authorizing entity computer;
receiving, by the server computer, a provisioning response message from the authorizing entity computer; and
providing, by the server computer, a second token to a second token requestor, the second token being associated with a first token stored in a first token requestor, wherein the first token and the second token are associated with a credential.

2. The method of claim 1, wherein the second token is provided to the second token requestor via the first token requestor.

3. The method of claim 1, wherein the second token is provided to the second token request device without passing through the first token requestor.

4. The method of claim 1, wherein the message is received from the second token requestor.

5. The method of claim 1, wherein the message comprises the first token.

6. The method of claim 1, wherein the message includes a cryptogram request message, and wherein the method further comprises:
transmitting, by the server computer, the first token and a cryptogram associated with the first token to the first token requestor.

7. The method of claim 1, wherein the second token is provided to the second token requestor via an application programming interface (API) in an API response message.

8. The method of claim 1, wherein the provisioning request message that is sent to the authorizing entity computer comprises the credential.

9. The method claim 8, wherein the authorizing entity computer programmed to bind a device identifier for the first token requestor to the second token.

10. The method of claim 9, wherein the providing of the second token to the second token requestor is performed after the message is received by the server computer, but is not responsive to the receipt of the message by the server computer.

11. The method of claim 1, further comprising:
updating, by the server computer, a token store to include the second token as mapping to the credential, an identifier identifying the first token requestor, and the first token, wherein the credential comprises a primary account number.

12. The method of claim 11, wherein the first token requestor is a mobile phone and the second token requestor is an application server that operates an application on the mobile phone.

13. A server computer comprising:
a processor; and
a non-transitory computer readable medium, the non-transitory computer readable medium comprising instructions, executable by the processor, to cause the processor to:
receive a message;
after receiving the message, transmit a provisioning request message to an authorizing entity computer for verification of a credential associated with a first token specific to a first token requestor;
receive a provisioning response message from the authorizing entity computer indicating whether the credential is verified;
obtain a second token, the first token and the second token both associated with the credential; and
provide the second token to a second token requestor, the second token being associated with the first token stored in a first token requestor.

14. The server computer of claim 13, wherein the second token is bound to a device identifier associated with the first token requestor.

15. The server computer of claim 13, wherein the message includes a request for a cryptogram for a transaction conducted using the first token, and wherein the non-transitory computer readable medium further comprises instructions which cause the processor to:
transmit the cryptogram to the first token requestor in response to receiving the message.

16. The server computer of claim 13, wherein the non-transitory computer readable medium further comprises instructions, which cause the processor to:
update a token store to include the second token as mapping to the credential, a device identifier uniquely identifying the first token requestor, and the first token.

17. A method comprising:
receiving, by a second token requestor, a first token from a first token requestor;
transmitting, by the second token requestor, a provisioning request message requesting a second token from a server computer; and
receiving, by the second token requestor from the server computer, the second token, wherein the second token and the first token are each associated with a credential.

18. The method of claim 17, wherein the second token is received by the second token requestor via an application programming interface (API).

19. The method of claim 17, wherein the second token requestor is an application server.

20. The method of claim 17, wherein the first token requestor is a communication device operated by a user associated with the primary credential.
